(19) United States
(12) Patent Application Publication
(10) Pub. No.: US 2006/0216988 A1
(43) Pub. Date: Sep. 28, 2006

(54) Electrical receptacle and junction box free of wire-nuts

(76) Inventor: James L. Scott, Cowlesville, NY (US)

Correspondence Address: PATRICIA M. COSTANZO;PATS PENDING, P.O. BOX 101, ELMA, NY, 14059, US

(21) Appl. No.: 11/443,238

(22) Filed: May 30, 2006

Related U.S. Application Data
(63) Continuation-in-part of application No. 11/274,981, filed on Nov. 15, 2005.
Application No. 11/274,981 is a continuation-in-part of application No. 10/990,035, filed on Nov. 16, 2004.

(51) Int. Cl. H01R 13/60

(52) U.S. Cl. 439/535

(57) ABSTRACT

Junction boxes molded with wiring terminals and inserts molded with wiring terminal for use in existing junction boxes eliminate wire-nuts. Wiring terminals with or without quick connect connectors provide reversible electrical connections between conductors, other conductors, and/or electrical devices, such as switches and plugs. The box has least one opening through which at least one electrical conductor may be inserted. An open front face may receive an electrical device, such as a plug or a switch receptacle. At least one wiring terminal block is integrally molded onto said connection box or onto an insert device. The wiring terminal comprises a set of apertures for the insertion of the wires to be connected and wire securing means, such as a set screw or quick connects. The box may be made of any moldable material, such as plastic or the like. The wiring terminal may be made of conducting or non-conducting material.

### CROSS-REFERENCE TO RELATED APPLICATIONS

This Continuation-in-Part Application claims the benefit-in-part of U.S. application Ser. No. 10/990,035 filed 11.16.2004, presently pending, and U.S. application Ser. No. 11/274,981 filed 11.15.2005, presently pending.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to electrical receptacle junction boxes and, more particularly, to electrical receptacle junction boxes having electrical wiring connectors means for economical, safe, quick, reversible, and easy wiring of electrical devices, such as switches and plugs, without the use of wire-nuts. The invention, if desired, may be used with existing junction boxes as the electrical connector means is available as an insert that is easily and rapidly positioned in and, if desired removed from, presently available junction boxes. Molded into the connector blocks are what is known in the industry as quick connect (QC) wire connections that may be as simple as a resilient metal leaf spring.

The background information discussed below is presented to better illustrate the novelty of the present invention. This background information is not admitted prior art.

In order to provide for electrical power inside a building, wires carrying electricity are brought into the building from an outside source. Generally, this means connecting an electrical power supply line (also referred to as a wire, a lead wire, or an electrical conductor) to a main box just inside or outside the building. Once inside, electrical conductors must be routed through the walls of the building to the many areas where power is desired and/or required. Once the electrical conductors are positioned within the structure, they must then be connected to either electrical devices or to continuing electrical conductor supply lines to ultimately supply electrical power for an end use, such as for light switches, plug outlets, and the like. Electrical conductors are usually connected to other electrical conductors or to electrical devices within a junction or receptacle box, respectively. A junction box is essentially a container to house electrical conductor connections. The actual electrical connections between a lead line and a wire emanating from an electrical device, such as a light-switch, may be first encased inside of a plastic “wire-nut” which is nothing more than a thimble-shaped and sized plastic cup designed to force the ends of wires together. The wire-nuts with their protruding wires are then housed in an electrical connection box. If a wire-nut is not used to make the connection, electrical tape may be used, although this is considered an unsatisfactory solution as it is well-known that electrical tape loses its properties with time.

Wire-nuts, while supposedly providing for an improvement over the use of electrical tape to secure electrical connections, provide little protection against wires that are connected within the nut becoming disconnected. This is a particular problem where several wire-nut encased wires are positioned within a junction or receptacle box and then must be hard-pressed into the box so that a switch and a switch plate cover is able to be secured over the opening of the box. Squeezing the wire-nut encased wires into the box in such a manner often results in broken connections.

In fact, wires that have been connected within a wire-nut become disconnected so frequently that some wire-nuts are now designed to be crimped. That is, once the wires to be connected are connected and placed inside of the wire-nut, the wire-nut is permanently crimped closed using a wire-nut crimper to ensure that the connected wires inside of the nut stay connected. One of the negative repercussions of crimping wire-nuts, however, is that if a repair or replacement is required after the wire-nut has been crimped, the wires must be cut free from the crimped wire-nut, as it is impossible to remove the wires from the wire-nut after the wire-nut has been crimped. Cutting the wires, however, results in shortened wires which may complicate or eliminate the possibility of any reconnection. This of course, will then require a whole new switch plate with new wires or the wires will have to be spliced which can pose additional safety concerns. And, of course, incomplete crimping may cause the same problems as uncrimped wire-nuts cause that is, a loose connection.

Attempts have been made to provide for securing an electrical receptacle within an outlet box in electronic communication with wiring systems. One example offers an electrical junction box configured to receive electrical conductors through openings in each of the end panels of the box. Each electrical conductor is held in place by clamping means that are located adjacent to an opening. The clamping means, however, includes a contact shoe which is initially formed with the housing, but which is designed to be separated from the housing when the conductor is to be clamped. Breaking a tab that initially anchors the shoe to the housing enables the shoe to be brought into clamping engagement with the conductor at which time the shoe is secured to the housing. However, once the shoe is broken away from the housing to clamp the conductor to the box, it would be difficult to use the box again. If a receptacle or wires need to be replaced or relocated, the box also would have to be replaced. Moreover, such devices do not offer means to connect wires to each other. They are designed only to hold a wire cable secure within the box. These devices require many design features that are structurally complex, suggesting that its manufacturing cost is likely to be relatively high, and thus, unlikely to be universally affordable. It certainly would be desirable to have an affordable, uncomplicated outlet box that provided for the simple, easy, and rapid attachment and detachment of wires as many times as required, without the need to replace the box or any parts of the box.

Another plug and switch receiving device that attempts to offer improved means for securing wires, comprises a complex, multi-part receptacle box that requires at a minimum two discrete pieces that must be attached to each other before the box can be attached to a structure so that a plug, switch, or similar device is able to be attached to a electrical conductor within the box. Another example comprises a plug receptacle that must be first attached to a first front part of a receptacle box and then to a second inner part of the box using spring clips that are designed to extend through the first and second parts to reach a third part at which point connection is made between electrical device wires and a electrical conductor. Such spring-type clips, however, are prone to a loss of their springiness, to breakage, and/or rusting, if metal. This type of custom made device is complicated and requires all of its parts to be specially made, which of course adds significantly to the cost of manufacture. Such devices cannot accept off-the-shelf receptacles or switches as they do not come provided with the requisite prongs for fitting into the spring clips.

Another attempt teaches a specialized style of electrical receptacle outlet box that offers off-set mounting panels adjacent to either side of the box opening. Each mounting panel is angled away from the box opening to allow for easy access of the wiring terminals that are mounted on the interior side of these panels and to allow for conventional wiring to be pre-terminated within the outlet box. Each wiring terminal is shown having a single aperture to accept both wires and wire holding means, which could compromise the integrity of the wires that are positioned in the aperture. Additionally, the atypical shape of such boxes suggests that they would not likely be an acceptable candidate for use in commercial or home construction. Furthermore, these unusually shaped boxes would be much more complex to manufacture and thus are likely to more costly. Another need that has not been addressed and is found lacking by a large segment of the industry is the need for wiring terminals that are molded as part of either a receptacle box or as part of an insert of an insert for an electrical box that are provided with quick connect electrical connections.

Accordingly, it would be a significant improvement in the art to provide for an economical, easy to use, electrical receptacle junction box of simple design that would allow a user to rapidly and repeatedly, if required, pre-wire or wire conventional residential, commercial, or industrial buildings, especially prior to enclosing such wiring systems behind drywall or other interior wall finish without using wire-nuts, such that the remaining wiring of standard electrical receptacles is easily and safely completed. It would be additionally beneficial if the receptacle box had either molded-in electrical wire connector blocks or electrical wire connector blocks that were molded-into an insert that easily and rapidly dropped into and lifted out of a presently available electrical receptacle junction box, especially if the electrical wire connector blocks of either embodiment were optionally fitted with quick connect electrical connectors.

### SUMMARY

The present invention satisfies the urgent need in the art for a molded box-like container that provides for either an electrical wire connector or junction box that eliminates the need for the ubiquitous nut connectors of questionable safety that are presently relied on to connect conductor wires inside a junction box. The molded box is of simple, streamlined, and economical construction. The electrical receptacle box according to the principles of the present invention allows a user to rapidly and repeatedly pre-wire, wire, or re-wire conventional residential, commercial, or industrial wiring systems. Additionally, the present invention satisfies an urgent need in the art for an electrical wire connector insert for use in existing junction boxes eliminating the need for the ubiquitous nut connectors. The electrical receptacle insert according to the principles of the present invention provides for a user to rapidly pre-wire, wire, or re-wire conventional residential, commercial, or industrial wiring systems using presently available junction boxes. Wiring terminals blocks made of conducting or non-conducting material, molded into the box and inserts, provide reversible electrical connections between conductor wires and other conductor wires or between conductor wires and electrical devices.

The present inventions successfully alleviate the problems commonly suffered when wire-nuts or crimped wire-nuts are used to make wire connections in presently available electrical connector or junction boxes. The present invention provides for a box that is molded in one piece where the wiring terminals (also referred to as block connectors, block terminals, or terminal blocks) are molded into the box to become an integral part of the box. These wiring terminals comprise small, mainly hollow, box-like interior extensions positioned within a junction box of any desired size or shape. The number of wiring terminals in a box is determined by the number of connections required. The low cost of these boxes, however, would allow multiple wiring terminals to be a part of each box, so that various box models would not be required. Within the body of each wiring terminal is a space that is accessible by a first and a second aperture. The wires from the electrical conductor and the electrical device are placed into one aperture and secured by the tightening of a screw, or the like, that is placed into the second aperture. Tightening of the screw prevents the wires from inadvertently becoming disconnected, yet loosening of the securing means allows the connected wires to be disconnected, if necessary, and reconnected, if desired. The fixed position of the wiring terminals ensures that once the connected wires are fixedly secured and protected by the securing means, the wire connection need not be disturbed and thus is safe from having the connection broken, unlike connections that are made within moveable wire-nuts. However, when there is a need to disconnect the connected wires, the screw or other securing means is easily loosened and the wires removed without any need to cut the wires or to prevent further use of the device. Moreover, the tightening means is usually a ubiquitous means, such as a screw, which means is easily replaced at minimal cost in case the original tightening means is misplaced or damaged.

Each junction box may have three or four electrical wire connector blocks. If, for example, the box is to be used where a dual room switch is desired, a four electrical wire connector block junction box would be used. Each electrical wire connector block may have from three to six wire connector apertures. When the box is manufactured as a double box, that is, if the box is meant to hold, for example, a pair of plug plates, electrical wire connector blocks having four wire connector apertures would be used.

Molded into the connector blocks may be what is known in the industry as quick connect wire connections. Quick connects may be as simple as a resilient metal leaf spring. Each connector box may have three or four wire connector apertures with each aperture accompanied by a quick connect release opening. First a wire is inserted into a wire connector aperture where it is automatically held firmly in place by the pressure action of the molded into the block leaf spring quick connect spring tab. When it is desired to remove the wire, an object, such as a screw driver is poked through the quick connect release opening, thus releasing the pressure of the quick connect leaf spring on the wire.

For those situations where it would be desirable to use presently available junction boxes, the present invention also teaches a non-conducting electrical wire connector insert that fit easily, yet securely, in existing junction boxes. Following the principles of the present invention, the insert is molded from a non-conducting material and is shaped and sized to be dropped into preexisting junction boxes. The insert provides for easy and rapid connection of wires, such as for connecting the wires from a power source to the wires that are part of a switch box. Each insert, as with each connector box, is capable of accepting one or a plurality of wire sets for connection of the wires in each set. The inserts, as with the connector boxes, may be made entirely from a non-conducting material, or they may be made of plastic with metal connector blocks. Inserts made entirely of a non-conducting material, such as plastic are ideal for use in metal junction boxes. Alternatively, the frame of the inserts may be made of plastic containing press-fitted metal connector blocks for use in junction boxes made of plastic. Each wire connector block has at least one cavity for accepting wires to be electrically connected. The wires are held in position in the cavity by connector means, such as a set screw. The connector block has at least one aperture for receiving a connector means, which aperture is in communication with the at least one cavity for receiving the wires to be electrically connected. The connector means is positioned, such as by screwing, for holding the connected wires in position in the cavity. The insert is of extremely simple, streamlined, and economical construction and provides the same advantages as the full-sized connector. The number of wiring terminals in an insert is determined by the number of connections required in each junction box. The low cost of these inserts, however, would allow multiple wiring terminals to be a part of each box, so that various box models would not be required.

In addition to providing for easier, more rapid, more secure, and safer connections within an electrical junction box, as well as eliminating the need for wire-nuts, or for any other type of wire connector, such as electrical tape (which it is well-known is not a recommended choice), the present invention, both the full-sized connector box and the insert, which is analogous to a mini-sized connector box, provides more room in the box for switches, receptacles, or both. For example, in the case of boxes designed to accept multiple switches or receptacles, the box would have multiple wiring or block terminals (that are either all plastic or metal). All block terminals are molded into the box or pressure fitted into the molded insert when they are manufactured and would be made of a known, or yet to be known, conducting material, such as copper or aluminum or, for use in metal boxes, of a non-conducting material, such as plastic, glass, ceramic, and the like. Set screws, or other means for securing the connecting wires, are provided with each box. Moreover, no extra parts are needed for the installation or of the junction box as described herein, preventing the need for last minute trips to the hardware store because a required piece of hardware is missing.

Because the junction box and the insert may be molded in one piece from a variety of non-conductive materials, such as plastic, it can be mass-produced at low cost making the device attractively affordable to all. If desired, however, the box may be made from a variety of other materials, such as fiber glass or ceramic, and even such conductive materials, such as steel, aluminum, or the like, may be used provided that any conductive material would insulated. Additionally, the molding process is amenable to the easy addition of an anchoring device to the box, such as a series of eye holes to be added to the molded junction box during production without incurring significant additional cost, while simultaneously increasing the versatility of the device. Also, as the box can be made through any standard molding technique, a wide range of shapes and sizes, depending on the desired use, may be contemplated while within the scope of the invention. For example, the size, and perhaps the shape, of a box used for the installation of a light switch would be different than that of a box to be used as a junction box for five electrical conduits.

Just as with the electrical wire connector blocks that are molded as a unitary part of a receptacle junction block, the present invention, as mentioned above, also contemplates electrical wire quick connects to be molded into electrical wire connector blocks that are molded as a unitary part of an insert. The electrical wire connector blocks are molded into and as part of the insert adjacent each corner of the insert. Each electrical wire connector block contains a plurality of wire connector apertures. Each wire connector aperture has an associated quick connect release opening that is used for disengaging the quick connect connection holding the inserted wire. There are many styles of quick connect devices. One common quick connect comprises a resilient metal leaf spring that provides as many up-turned spring tabs as needed for holding the wires in the wire connector apertures. The quick connect connections are molded into the connector blocks of the inserts just as they are molded into connector blocks that are molded into the inside corners of a junction box, as described above. Each junction box insert may have three or four built-in connector blocks. If, for example, the junction box and insert are to be used where a dual room switch is desired, a four connector block junction box insert would be used. Each connector block has from three to six wire connector apertures. If the insert were to be manufactured to fit a double box, that is, if the box and insert were meant to hold, for example, a pair of plug plates, a connector block having four wire connector apertures would be used.

All of these advances and advantages are made available by providing for a molded electrical receptacle box, comprising: a back panel; a first side panel and a second side panel; a first end panel and a second end panel; where the back panel, the side panels, and the end panels are adapted to form accessible internal volume, where the end panels have at least one opening that is configured to receive at least one electrical conductor therethrough for positioning in the accessible internal volume of the molded electrical connection box, and where an open front face, which is opposite to the back panel, is configured to receive an electrical device, and where at least one wiring terminal block is integrally molded onto the connection box providing for reversible electrical connection between the conductor and an electrical device.

Moreover, the molded electrical receptacle box, further comprises wherein the wiring terminal is designed as a block terminal, which terminal may be made of a conducting material that may or may not be faced with a non-conducting material.

The molded electrical receptacle box provides for an electrical conductor to be secured into at least one of the block terminals by a securing means, which may be a set screw or the like.

The electrical device that is received into the open front face may be any type of electrical device such as a plug receptacle or a switch, for example.

The molded electrical receptacle box further comprises wherein the block terminal has an at least first aperture opening to an at least second aperture, wherein at least one electrical conductor and at least one wire from an electrical device are positioned into at least one second aperture wherein electrical connection is made between said electrical conductor and electrical device and wherein said electrical connection is secured by a securing means that is positioned into said at least first aperture.

The molded electrical receptacle box may be molded by any known molding means and, therefore, may be manufactured from a plastic, metal, or other material. The molded electrical connection box may be molded with means for mounting the box to a support.

Another molded electrical box, comprises: a back face panel; a first side panel and a second side panel; a first end panel and a second end panel; where the back panel, the side panels, and the end panels are adapted for forming accessible internal box volume, and where the end panels have at least one opening configured to receive at least one electrical conductor therethrough for positioning in the accessible internal volume of the box, where at least one wiring terminal is integrally molded onto the connection box, wherein the wiring terminals provide for reversible electrical connection between electrical conductors, in the manner that is discussed above.

The molded electrical junction box wherein the wiring terminal may be a block terminal, wherein the block terminal may be made of a conducting material that may, or may not be, faced with a non-conducting material.

A favored embodiment provides for a wire connector insert, for insertion into a junction box, comprising: a. a frame; b. at least one wire terminal integral within the frame, the wire terminal for receiving at least a first and second wire, c. at least one means for fastening the at least first and second wire together within the wire terminal, the fastening means providing for reversibly firmly connecting the at least first and second wire together. The frame is sized and shaped for being held securely within a junction box and is made of a non-conducting material, which material may be of any desired non-conducting material, such as plastic, ceramic, or glass. If desired, the insert is available with the at least one wire terminal made of a non-conducting material. Alternatively, the insert is available with the at least one wire terminal made of a conducting material, which is insulated from its environment.

Another favored embodiment provides for a wire connector insert, comprising: a. a frame; b. at least one cavity for receiving at least one set of wires to be connected, the cavity integral with the frame; c. at least one means for fastening the at least one set of wires to be connected, and d. at least one hollow in communication with the cavity, the hollow for receiving the at least one means for fastening, wherein when the at least one means for fastening is received into the hollow for reversibly firmly connecting the at least one set or a plurality of sets of wires to each other with the cavity. The insert is sized and shaped to be received and held snugly within a junction box, wherein the insert frame is made of a non-conducting material. The insert may comprise two or more cavities for receiving wires to be connected and at least one of the hollows further comprises two or more hollows where each hollow is in communication with one cavity providing for wire connection. Where the frame is made of a non-conducting material, at least one connection block for connecting the wires to be connected may be conducting and may be positioned within the frame of the insert by press insertion. In this favored embodiment the at least one cavity and the at least one hollow are positioned within the conducting connection block, which is electrically insulated from the environment outside of the frame. If desired, this embodiment is available with at least two cavities for receiving wires to be connected and at least two hollows each of which is in communication with one cavity. Importantly, this favored embodiment is available with the frame is made of a non-conducting material having at least one non-conducting connection block for connecting the wires to be connected, the non-conducting block molded together with and within the frame.

A yet another favored embodiment, provides for a molded, non-conducting, electrical receptacle connection box, comprising a molded, non-conducting electrical receptacle connection box, comprising: a. a non-conducting frame; b. at least one non-conducting wire terminal for receiving wires to be connected, the wire terminal structurally molded within the frame having: i. at least one non-conducting wire terminal cavity for receiving wires to be connected; ii. at least one means for reversibly firmly connecting the wires to be connected within the wire terminal cavity, and iii. at least one non-conducting hollow structurally integrated into the frame in communication with the cavity, said hollow for receiving the at least one means for reversibly firmly connecting the wires to be connected within the cavity.

There are electricians who prefer electrical wire connection means to be quick connect connection means, therefore, the present invention includes quick connect connections as part of the wiring electrical wiring terminals. The quick connect connections are simply another securing means, as discussed above. The electrical wire quick connects may be molded, or otherwise inserted into, the electrical connector wiring blocks that are a part of a junction box as described above and below.

The quick connect electrical connection assembly are presented by providing for a junction box for wiring electrical devices, where the junction box has at least one opening to receive an electric power-receiving member, and where the junction box has at least one other opening to receive a cable bringing electric power to be received by the at least one power-receiving member; and where the junction box has a plurality of wiring terminals molded to itself at spaced locations thereon; and where the plurality of molded wiring terminals are each adapted to receive and securely reversibly grip using quick connect connection means at least a wire of the power-receiving member, wherein each of the plurality of molded wiring terminals are adapted to receive and securely reversibly grip, using quick connect connection means at least a wire of the cable bringing power to be received by a power-receiving member; so that when the wire of the power receiving member is received and secured by one of the molded wiring terminals and a wire of the cable is received and secured by the same of the molded wiring terminals the power receiving member is wired.

Moreover, the junction box further comprises a receptacle junction box made from a non-conducting material, such as plastic, fiberglass, ceramic, or glass. It is contemplated where the at least one wiring terminal is made of a conducting material and comprises a block terminal of any suitable size or shape.

Wiring terminals may contain any desired number of apertures for receiving wires to be connected, thus the block terminal likely has multiple sets of first apertures that are connectedly open to second apertures. To make a connection between wires that require electrical connection using one wiring block (wiring terminal), at least one electrical conductor is positioned into a second aperture of a first set and secured therein by a securing means positioned into a first aperture of the first set, and at least one wire of the electrical device is positioned into a second aperture of a second set (located in the same wiring terminal) and secured therein by a securing means, such as a quick connect connecting securing means positioned into a first aperture of the second set providing for electrical connection between the electrical conductor and the electrical device.

Furthermore, the present invention contemplates a quick connect electrical connection assembly, comprising:
a) a receptacle junction box for wiring electrical switch devices and electrical plug devices,
   the receptacle junction box adapted for receiving and securing at least one electrical switch device and/or at least one electrical plug device, the at least one electrical switch device and the at least one electrical plug device each an electric power-receiving member;
   the receptacle junction box having at least one opening to receive a cable bringing electric power to be received by the at least one power-receiving member;
b) a plurality of wiring terminals molded to the receptacle junction box at spaced locations thereon;
   the plurality of molded wiring terminals each adapted to receive and securely reversibly grip using quick connect connection means at least a wire of the cable bringing power to be received by a power-receiving member;
   the plurality of molded wiring terminals each adapted to receive and securely reversibly grip using quick connect connection means at least a wire of the power-receiving member,
      when the wire of the power receiving member is received and secured by one of the molded wiring terminals and a wire of the cable is received and secured by the same of the molded wiring terminals the power receiving member is wired.

Yet still another embodiment of the present invention is a molded wire connector insert for insertion into a junction box, comprising:

an insert frame having a plurality of quick connect wiring terminals manufactured as part of the insert frame at spaced locations therein for receiving wires to be connected,
the plurality of wiring terminals each adapted to receive and securely reversibly grip using quick connect connection means at least a wire of a power-receiving device,
the plurality of wiring terminals each adapted to receive and securely reversibly grip using quick connect connection means at least a wire of the cable bringing power to be received by a power-receiving device;
   wherein when the wire of the power receiving device is received and secured by one of the quick connect wiring terminals and a wire of the cable is received and secured by the same of the quick connect wiring terminals the power receiving member is wired.

The wire connector insert may further comprise an insert for a receptacle junction box adapted for receiving and securing at least one electrical switch device and/or at least one electrical plug device, the at least one electrical switch device and the at least one electrical plug device each an electric power-receiving member.

It is contemplated that the insert may be made solely of a non-conducting material, such as plastic, ceramic, or glass, and wherein at least one wire terminal is made of a non-conducting material or alternatively, where at least one wire terminal is made of a conducting material that is insulated from its environment, and may be electrically insulated from the environment outside of the frame. Alternatively, the insert frame may be made of a non-conducting material having at least one non-conducting connection block for connecting the wires to be connected, the non-conducting block molded together with and within the frame.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1 is a perspective top view of the junction box according to principles of the present invention.

FIG. 2 is a perspective bottom view of the junction box as shown in FIG. 1.

FIG. 3 is a partial perspective sectional view of an inner side panel of the junction box taken along line 3-3′ of FIG. 1.

FIG. 4 is a partial perspective sectional view of the opposite inner side panel of the junction box taken along line 44′ of FIG. 1.

FIG. 5 is a perspective view of the junction box wire connector insert according to principles of the present invention.

FIG. 6 is an exploded view of the junction box and insert, as shown in FIG. 1, along with an electrical device with its matching cover plate.

FIG. 7a is a perspective view of a junction box with the insert of this invention, an electrical device, and a cover plate of the electrical device in position for use.

FIG. 7b is a sectional plan view of the junction box taken along line 7a-7a of FIG. 7.

FIG. 8a is a top plan view of a junction box wire connector insert made from non-conductive material utilizing one cavity and one hollow per set of wires to be connected.

FIG. 8b is a side plan view of the insert as illustrated in FIG. 8.

FIG. 8c is a end plan view of the insert as illustrated in FIG. 8.

FIG. 9a is a top plan view of a junction box wire connector insert made from non-conductive material fitted with conducting connecting blocks.

FIG. 9b is a side plan view of the insert as illustrated in FIG. 9.

FIG. 9c is a end plan view of the insert as illustrated in FIG. 9.

FIG. 10a is a perspective top view illustrating a non-conducting junction box having non-conducting terminals that are molded integral with the box according to the principles of the present invention.

FIG. 10b is a section view taken along 10b-10b further illustrating a non-conducting junction box.

FIG. 11 is a top plan view of a junction box with four rectangular wire connector blocks molded as part of the box body with four wire connector apertures and four quick connect connector release openings per block.

FIG. 11a is a cross-section taken along line 11a-11a to illustrate one example of a quick connect wire connection comprising a leaf spring

FIG. 11b is a perspective partial view of a junction box showing a triangular wire connector block molded as part of the box body with four wire connector apertures and four quick connect connector release openings per block.

FIG. 12 is an exploded view of the junction box and insert along with an electrical device with its matching cover plate.

Definitions

Integral, as used herein, refers to a whole made up of parts, wherein the parts are formed united as one unit and are all of one and the same single piece.

Molded, as used herein, refers to any process wherein an object is produced as one solid piece, either by casting, forming, injection into a mold, or any other acceptable means that provides for a integral construction.

Electrical Device, as used herein, refers to any device that either uses or implements electricity, which includes, but is not limited to, plug receptacles, switch plates, and the like.

Block or Wiring Terminal, as used herein, refers to a means for connecting electrical wires and may be referred to as terminal blocks, connectors, connecting blocks, wire connectors and the like. The block terminals comprises a small, relative to the electrical connector box of which it is a part, container having at least two apertures that are internally connected to one another for receiving connecting wires and securing those wires through the use of securing means, such as screws. Following the principles of the present invention, the block terminal(s), which may be of curvilinear as well as block form, provide for rapid, safe, and secure connection of electrical wires and, if desired, provides for the connection(s) to be unsecured without damaging the wires, the securing means, or the block terminal.

Electrical Conductor, as used herein, refers to any wire or cable that carries an electrical current.

### A List of the Reference Numbers and Related Parts of the Invention

10 molded electrical junction or receptacle connector box according to the teachings of the present invention.
12a-12d Means, such as mounting flanges, for securing box 10 to a support feature.
13a-13d Apertures through which attachment means (not shown), such as convention screws, nails, bolts, or the like, may extend to mount box 10 on a support feature.
14a & 14b Cable openings providing cable support and cable access to interior of box 10.
20a An exterior side panel of box 10.
22a An exterior end panel of box 10.
24b An interior side panel of box 10.
26b An interior end panel of box 10.
28a An exterior bottom panel of box 10.
30a-30d Plug and switch plate mounting means.
32 Connection flanges attaching and supporting 30a-30d, 32a, and 32b to interior end panels of box 10.
32a & 32b Plug and switch receptacle mounting means.
40 Block or wiring terminal in which wires with ground wires are fastened.
42 & 44 Block or wiring terminal in which electrical wires are fastened.
50 Fastening means for securing wires, a set screw, for example.
52 Aperture in which wires are positioned for fastening.
112 Junction box to house electrical conductor connectors.
114 Aperture for receiving attachment means for attaching an electrical device to 112.
116 Cable for containing electrical wires.
120 Non-conducting electrical conductor connector insert.
122 Cavity in which wires to be connected are positioned.
124 Aperture for receiving connector or fastening means 126.
126 Connector or fastening means for maintaining wires in contact.
132a Wire transporting electrons from electricity source to electrical device wire 132b.
132b Wire to transport electrons from 132a to electrical device.
133a Wire carrying electrons away from electrical device to electricity source wire 133b.
133b Wire transporting electrons from 132a to electrical source.
134a Grounding wire.
134b Grounding wire.
132d Wire connector means.
133d Wire connector means.
132d Wire connector means.
140 Electrical device.
142a Attachment means.
142b Aperture for attachment means 142a.
143 Switch.
150 Cover plate.
152a Attachment means.
152b Aperture for attachment means 152a.
153 Switch aperture.
160 Metal block.
170 Non-conducting cover plate.
215 Non-conducting junction box
216 Aperture for wire cable or the like.
220 A molded electrical receptacle connector junction box according to the teachings of the present invention.
225 A molded electrical receptacle connector junction box according to the teachings of the present invention.
240-246 Rectangular shaped electrical wiring terminals (i.e., blocks) for fastening electrical wires.
250 Apertures in electrical wi ring terminals 240-246 in which electrical wires are positioned for fastening.
252 Quick connect connector release openings that are used for disengaging the quick connect securing the inserted wire
260-264 Triangular shaped electrical wiring blocks (i.e., terminals) for fastening electrical wires.
270 Quick connect connector tabs.
272 Quick connect connecting ribbon-like part.
312 A molded electrical receptacle connector junction box according to the teachings of the present invention.
314 Aperture for receiving attachment means for attaching an electrical device, such as a or a switch to box 312.
315 Non-conducting electrical conductor connector insert.
316 Cable for containing electrical wires bringing power to the electrical devices attached to the box.
320 Non-conducting electrical conductor connector insert with quick connect connectors molded in place for the quick connection of the electric wires.
322 Apertures in which electrical wires are positioned for quick connect fastening.
324 Quick connect connector release openings that are used for disengaging the quick connect securing the inserted wire
332a Wire transporting electrons from electricity source to electrical device wire 332b.
332b Wire to transport electrons from 332a to electrical device.
333a Wire carrying electrons away from electrical device to electricity out-source wire
333b Wire transporting electrons from 332a to electricity out-source.
334a Grounding wire.
334b Grounding wire.
332d Wire connector means.
333d Wire connector means.
334d Wire connector means.
340 Electrical device, here a switching device.
342a Attachment means.
342b Aperture for attachment means 342a.
343 Switch.
350 Cover plate.
352a Attachment means.
352b Aperture for attachment means 352a.
353 Switch aperture.

It should be understood that the drawings are not necessarily to scale. In certain instances, details which are not necessary for an understanding of the present invention or which render other details difficult to perceive may have been omitted. It should be understood, of course, that the invention is not limited to the particular embodiments illustrated herein, but encompasses many embodiments as are discussed throughout the specification.

### DETAILED DESCRIPTION

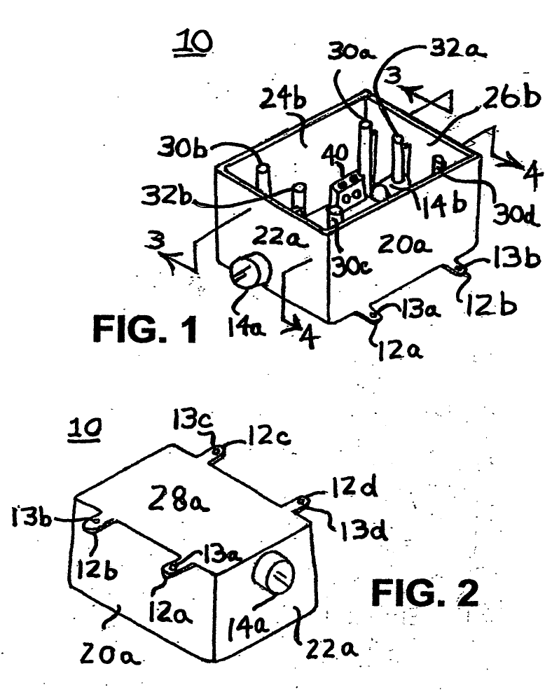

Referring now particularly to the drawings, FIG. 1 presents a perspective top view of the molded electrical connection box 10, which box is to be understood to be an exemplary embodiment of this invention. Box 10 demonstrates how the above mentioned disadvantages have been overcome. However, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

More particularly, FIG. 1 illustrates a molded electrical connection box 10 according to the teachings of the present invention. Box 10 consists of two end panels each having an exterior surface 22a and an interior surface 26b, two side panels each having an exterior surface 20a and interior surface 24b, and bottom panel with exterior surface 28a, wherein the end panels, side panels, and bottom panel are arranged to provide an inner volume that is to be used for the connection and storage of electrical and ground wires. Mounting flanges 12a-12d may extend from the bottom 28a and may be used to secure box 10 to a support feature, such as wall framing. It should be understood that the exact position of mounting flanges or other mounting means on the electrical conductor box may vary depending on need and such changes are within the scope of the present invention. Apertures 13a-13d, placed through mounting flanges 12a-12d allow for an attachment means (not shown), such as conventional screws, nails, bolts, or the like, to extend through the apertures to provide for mounting of box 10 on a support feature.

FIG. 2, which provides a perspective view of the bottom of box 10, illustrates one example of mounting flanges 12a-12d integrally formed as an extension of bottom surface 28a of box 10, although, as mentioned above, the position, size, and style of the flanges or other mounting means may be changed, as required.

Extending through opposing sides of box 10 are cable openings and supports 14a and 14b providing for cable access to the interior of connector box 10 and for support of said cable so that the cable may be positioned in the inner volume of box 10 to make electrical connection to another electrical element within box 10. The examples illustrated in FIGS. 1 and 2 show cable openings 14a and 14b positioned through the end panels identified by their outer surface 22a and their inner surface 26b, respectively. Opening supports 14a and 14b are shown as being contiguous with the panels through which they extend, and additionally, may provide for another means of anchoring box 10 securely in place.

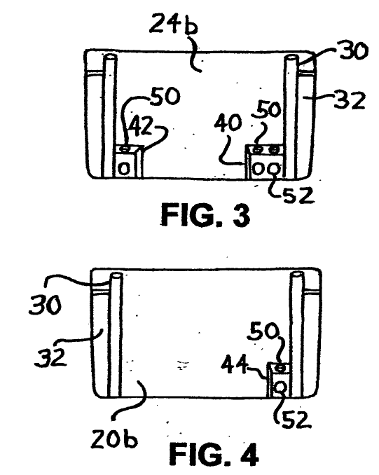

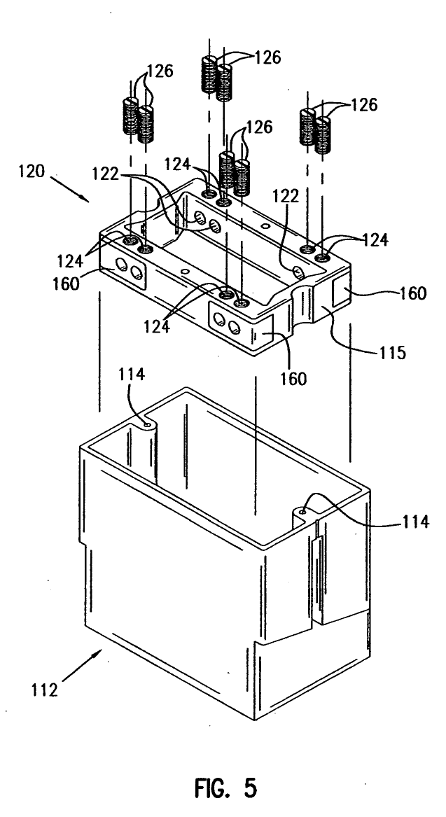

Also illustrated in FIG. 1, are pylons 30a-30d integrally formed as an internal part of molded electrical connector box 10 and functionally designed to provide for the reversible attachment of any standard receptacle, switch, or cover plate securely to the box. This attachment is accomplished by placing the desired cover (not shown) over the open front face of the box and by inserting any standard connection means, such as screws, through screw holes typically provided on such covers and into pylons 30a-30d, which are designed to accept and securely hold such connection means. Additionally, pylons 32a and 32b, also integrally formed as an internal part of molded electrical connector box 10, are functionally designed to provide in connector box 10 means for mounting an electrical device securely in the box 10, which, of course, is accomplished before a cover is placed over the box and the device secured to the box. Much like pylons 30a-30d, pylons 32a and 32b are designed to utilize any standard mounting means, including, but not limited to screws. Pylons 30a-30d and 32a and 32b are each supported and connected to the interior of end or side panels by a flange identified by reference number 32, as illustrated in FIGS. 3 and 4.

FIG. 3 provides a partial perspective sectional view taken along line 3-3′ of FIG. 1 illustrating inner surface 24b of one side panel of the junction box. Also illustrated are connector blocks 40 and 42 shown as being integral parts of box 10. It is contemplated that the block terminals are made of a conducting material, such as a metal, but can be of any desired material. If the block terminals are made of a conducting material, they may or may not be coated with a non-conducting material.

FIG. 4 provides a partial perspective sectional view taken along line 4-4′ of FIG. 1 of the inner surface of the side panel of the junction box that is diametrically opposite to the inner surface shown in FIG. 3. The entirety of box 10, including the internal components is molded of one piece, either from a plastic material, or from some other non-conducting material that would be suitable for a molding process. While any particular type of wiring terminal can be used in this instance, the exemplified preferred embodiment comprises block terminals, which, as mentioned, are integrally molded into box 10 during the molding process.

Two types of block terminals in the electrical box 10 are shown in FIGS. 3 and 4. Block terminals 42 and 44 in FIG. 3 and FIG. 4, respectively provide a housing in which electrical current carrying wires are connected to another electrical conductor or to an electrical device (not shown). Block terminals 42 and 44, should comprise at least two apertures, one for positioning therein the wires to be connected, which is illustrated as aperture 52 and a second aperture providing means for securely fastening the connected wires, which is illustrated as those apertures into which fastening means 50 is inserted. Comparatively, block terminal 40, as illustrated in both FIGS. 1 and 3, provides for grounding purposes. Like block terminals 42 and 44, block terminal 40 comprises at least two apertures, aperture 52 for the positioning of those wires that will provide a ground, and a second aperture providing means for fastening, which as illustrated is that aperture into which fastening means 50 is inserted.

To use the electrical connection box according to the principles of the present invention, one simply attaches the box to a support, which may be accomplished by using mounting means, such as mounting flanges 12a-12d. Once the box is attached to a desired support, at least one electrical conductor is inserted into the box via an opening, such as exemplified by cable openings 14a & 14b that provide for cable support and cable access to the interior of box 10. At this point the at least one electrical conductor is electrically connected to either another electrical conductor if the box is a junction box or to the wires emanating from an electrical device if the box is a receptacle box. The wires to be connected are inserted into a first aperture of a terminal block and secured therein by the secure placement of a securing means, such as a screw, into a second aperture of the terminal block, wherein the two apertures are connected so that the securing means may make secure contact with the wires. Thus, in this way a safe, secure connection is made between desired wires rapidly and economically. Once the conducting wires and ground are secured in the block terminals, if there is an electrical device it is now secured to the box via securing means inserted through apertures routinely provided in the device for just such a purpose and the apertures of pylons 32a and 32b. At this time a cover plate is placed over the box and secured in the usual manner.

If for any reason the connections made as described above are required to be disconnected, one simply reverses the process as follows. After taking the safety step of shutting off the electrical power, remove the cover plate, which removal is usually accomplished by simply unscrewing the screw-type cover plate securing means, detach the electrical device from the box, which detaching is usually accomplished by simply unscrewing the screw-type electrical device securing means from the apertures of pylons 32a and 32b, remove all fastening means 50 from their related apertures and remove the connected wires from aperture 52. At this point any connection made between a set of wires may be disconnected. This is accomplished without destroying any part of the electrical connector box so that the processes of connecting wires and disconnecting wires may be made without the use of wire-nuts and as often as required using the same box.

FIG. 5, a perspective view, illustrates non-conducting electrical wire connector insert 120 according to principles of the present invention positioned for insertion into junction box 112. Non-conducting electrical wire connector insert 120 is essentially a reduced sized molded electrical connection box 10, as described above. As will be shown, insert 120 has all the connecting functionalities of electrical connection box 10 but in a frame that is sized for easy and rapid insertion into an existing junction box, providing for very low cost, yet efficient and secure wiring and rewiring, wherever and whenever required. In particular, non-conducting electrical wire connector insert 120 comprises frame 115 providing for at least one wire terminal 160 for receiving wires to be connected structurally integrated into said frame, wherein wire terminal 160 provides for at least one cavity 122 in which wires to be connected are positioned. The wires to be connected within wire terminal 122 are reversibly firmly connected by at least one means for fastening 126. At least one means 126 for reversibly firmly connecting the wires to be connected. Connecting means 126 securely, yet reversibly, connects the wires to be connected when it is received and tightened into one of the at least one apertures 124 for receiving connecting means 126. Fastening means 126 my be loosened and removed as easily and rapidly from aperture 124 as it is received and tightened into aperture 124. This means that wires may be both connected and disconnected without destroying any parts of the connecting means, is an attribute not possible when using presently available ubiquitous wire nuts. Another advantage of either the n molded electrical connection box 10 or the reduced-sized version of the connection box which is referred to as electrical wire connector insert 120 is the fact that a connection, such as a switch device, can be disconnected and removed from the junction box without disturbing any other connections present in the junction box.

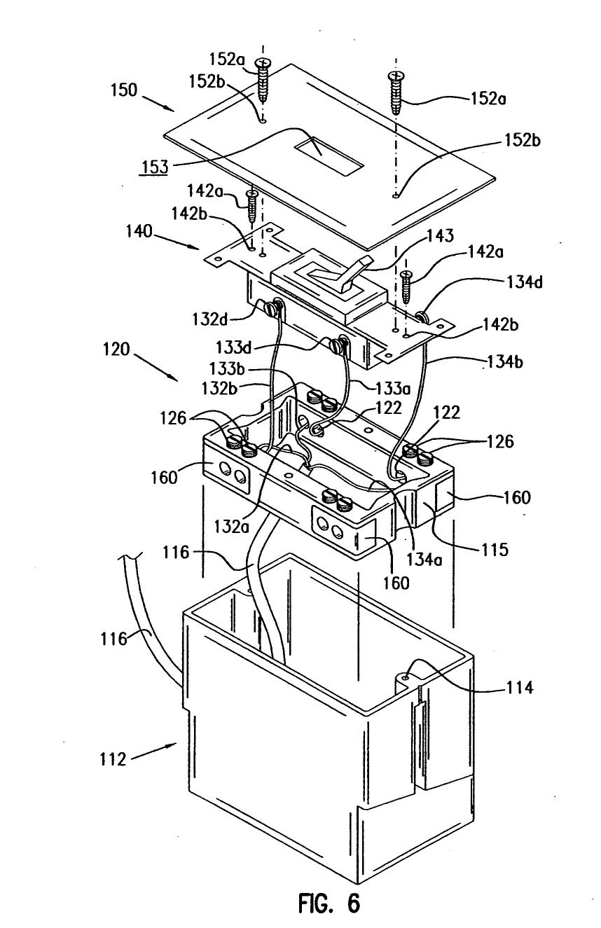

FIG. 6, an exploded view, illustrates the relationship between junction box 112, connection insert 120, an electrical device, which in this illustration is switch 140, and switch cover plate 150. In the example illustrated in FIG. 6, frame 115 of connection insert 120 is made of a non-conductive material, such as plastic. Into frame 115 metal connector blocks 160 are press-fitted. This construction, without any additional insulation about the metal blocks, provides connection boxes for use in junction boxes made of a non-conductive material, such as plastic. Each wire connector block 160 has at least one cavity 122 for accepting wires to be electrically connected. In the example illustrated in FIG. 6, it is should be noted that there are two cavities for each set of wires to be connected, i.e., one cavity per wire. Each of the two wires to be connected is positioned within one of the two of cavities per pair of cavities and is held in position in the cavity by one of the connector means 126, which are illustrated in the figures as set screws, but could be any comparable, known or yet to be known connection means. Set screw 126, once positioned in the relevant aperture 124, are tightened the reversible, secure connection is complete. As can be seen and appreciated, the insert is of extremely simple, streamlined, and economical construction and provides the same advantages as the full-sized connector box. The number of wiring terminals in an insert is determined by the number of connections required in each junction box. The low cost of the inserts, however, would permit multiple wiring terminals to be a part of each box, so that various box models would not be required.

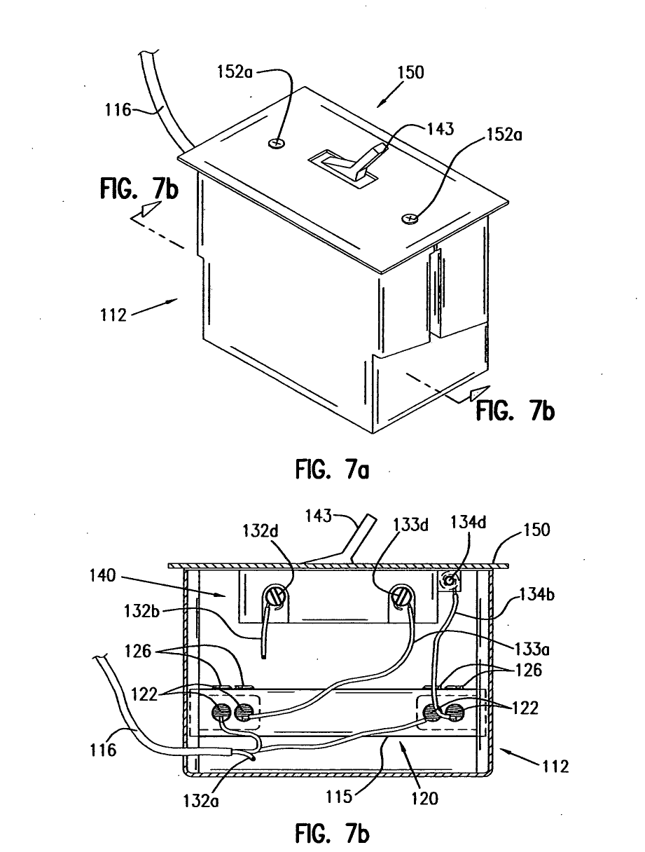

FIG. 6 further illustrates, for exemplary purposes, the “ac” power supply traveling to and from switch device 140 through wires 132a and 133b that are housed, along with ground wire 134a, in cable 116. In this example, the power travels to switch 140 through power source wire 132a and switch wire 132b. The wires carrying electrons in the other direction are switch wire 133a and power wire 133b. Switch 140 is grounded via wires 134b and 134a. Wire connectors, 132d, 133d, and 134d secure wires 132b, 133a, and 134b to device 140, respectively. Once all of the required wire connections are made, insert 160, electrical device 140, and device cover plate 150 are positioned into junction box 112. Insert 160 and electrical device 140 are secured to each other and to junction box 112 using securing means 142a that are inserted first into apertures 142b and then apertures 114 and tightened. Device cover plate 150 is then positioned on switch 140 so that switch 143 extends out through switch aperture 153 and then secured to electrical device 140 via securing means 152a that are inserted through apertures 152b to achieve a junction box ready for use, as illustrated in FIG. 7a.

FIG. 7b, a sectional plan view of the junction box taken along line 7a-7a of FIG. 7, illustrates how organized the wires inside the junction box are when the present invention is used to make the wire connections. FIG. 7b also illustrates how much room there is left in the box. This room provides for more connections to be made, if desired. Moreover, the space that is not required when wires are connected using the present invention provides for safer and more secure connections. Wire nuts require a substantial amount of space for each connection, which often leads to wire crowding inside of a junction box. Electricians have no recourse but to pack the wires together as best they can. Cramming wires into a junction box, however, often causes the wire connection to loosen, and even to break. This, of course, may result in, not only an inconvenience when the connection does not work, but in a worst case scenario, can also result in a fire hazard.

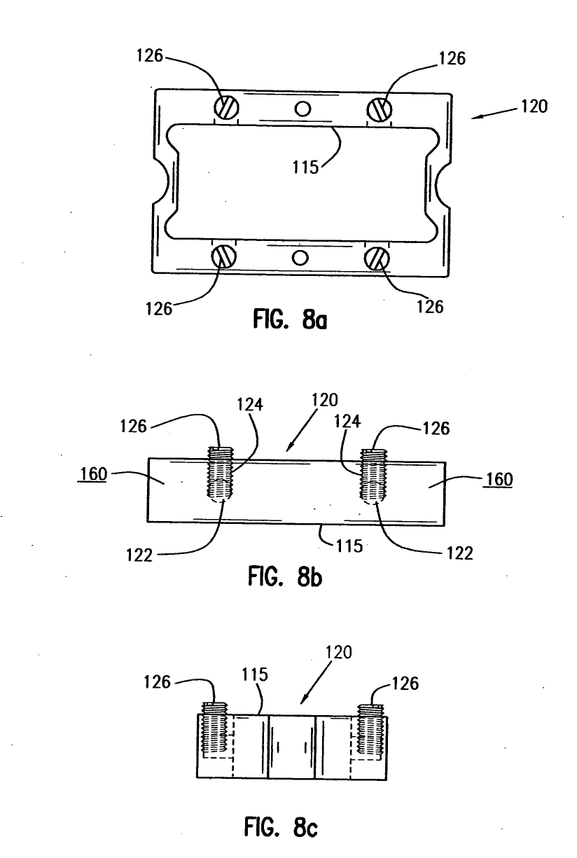

FIG. 8a, a top plan view, FIG. 8b, a side plan view, and FIG. 8c, an end plan view illustrate a junction box wire connector insert frame 120 made entirely from non-conductive material utilizing a single cavity 122 per at least one wire connection. Each cavity 122 is in communication with a hollow 124 for receiving wire connecting means 126. After the wires to be connected are positioned within a cavity 122 a connecting means 126 is positioned within hollow 124 and tightened to securely, and reversibly, connect one or more sets of wires. Connecting means 126 is likely, but does not have to be, a conducting material means.

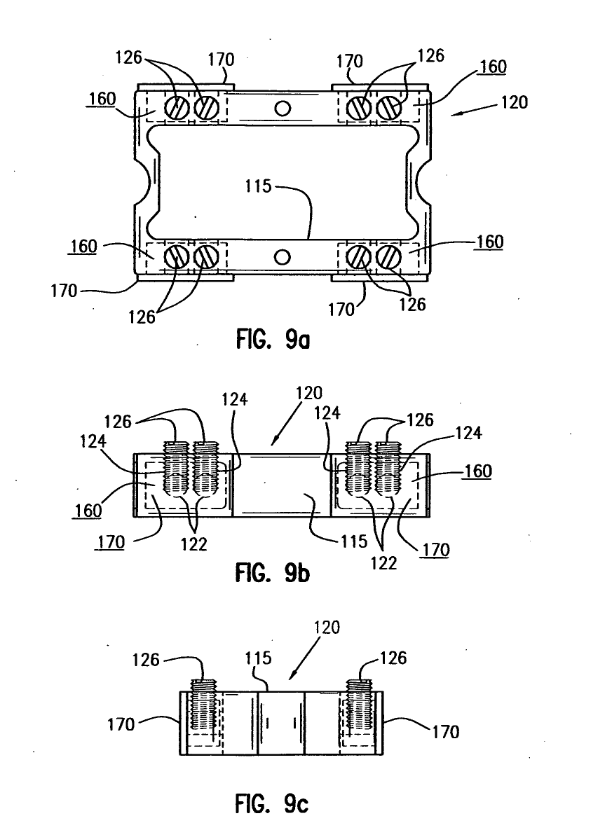

FIG. 9a a top plan view, and FIG. 9b, a side plan view, illustrate a junction box wire connector insert 120 with frame 115 made from non-conductive material, such as plastic, fitted with conducting connecting blocks 160 that provide the connecting structure basically identical to the examples described above. In this particular example, each conducting block has at least two cavities per electrical wire connection to be made. Into one cavity is placed a wire carrying power from a power source to a wire attached to an electrical device, such as a switch, for example, and into a second cavity is placed the wire that is attached to the electrical device. Although the wires are emplaced into physically separate cavities, they are in electrical connection, due to the presence of the conducting material from which the block is made. To reversibly secure the wire connection within the cavity, a securing means 126, such as a set screw, is positioned within a hollow 124 and tightened. Tightening of the screw prevents the wires from inadvertently becoming disconnected, yet easy and rapidly accomplished loosening of the securing means allows the connected wires to be disconnected, if necessary, and reconnected, if desired without any need to cut the wires or to prevent further use of the connecting device. The fixed position of the wiring terminals ensures that once the connected wires are fixedly secured and protected by the securing means, the wire connection need not be disturbed and thus is safe from having the connection broken, unlike connections that are made within moveable wire-nuts. In this example, which shows an example of a connector insert that may be used in a conducting junction box, insulating plates are secured over the conducting block, thus preventing any electrical contact between the conducting block and a conducting junction box.

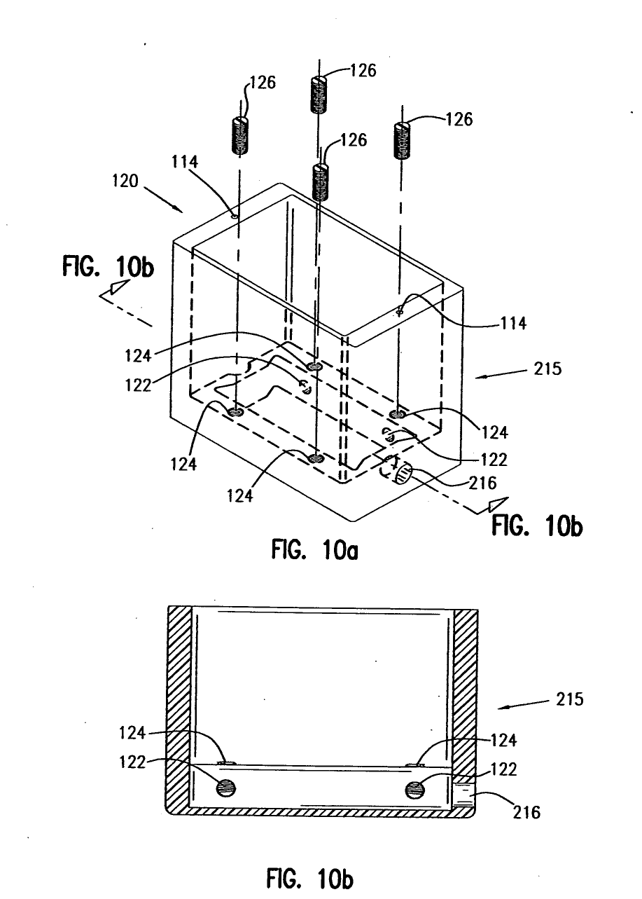

FIG. 10, a perspective top view, illustrates non-conducting junction box 215 having non-conducting terminals that are molded with the box forming one integrated unit according to principles of the present invention providing for a molded, non-conducting, electrical receptacle connection box, comprising at least one non-conducting wire terminal for receiving wires to be connected, the wire terminal structurally molded within the frame having: i. at least one non-conducting wire terminal cavity 122 for receiving wires to be connected; ii. at least one means 126 for reversibly firmly connecting the wires to be connected within the wire terminal cavity and, ii. at least one non-conducting hollow structurally 124 integrated into the frame in communication with the cavity, the hollow for receiving the at least one means for reversibly firmly connecting said wires to be connected within said cavity, wherein the box has at least one opening 215, as shown in exemplary FIG. 10, located in a side panel, configured for receiving at least one wire power input cable to be connected. It is to be understood that the number of non-conduction wiring terminal cavities will be as desired, which, of course, depends on the use to which the junction box is to be put. It will also be understood that the at least one means 126, while illustrated as a set screw in FIG. 10, can be any other desired type of wire connection means, for reversibly firmly connecting wires together within the non-conducting wiring terminal, it is to be equally understood that the number of number of connecting means for reversibly firmly connecting wires also will be as desired. The fully non-conducting electrical receptacle connection box provides for low-cost, safe, reversible, firm, connection of wires that are to be connected. The electrical receptacle connection box provides all of the functions of presently available junctions without the need for wire nut or pigtail connectors providing for reversible, safe, and sturdy electrical wire connections. Moreover, the present invention provides for desired connections to be removed with the need for disconnecting all of the connections made in the junction box. Being able to provide for a junction box and the required wire connectors to be made in a one step molding process means significantly reducing the cost of the several parts now required in order to make wire connections.

Thus, it has been shown that the present invention satisfies the urgent need in the art for a molded insert for use in an available junction box and for a molded box-like container that eliminates the need for the ubiquitous nut connectors of questionable safety that are presently relied on to connect conductor wires inside a junction box. The molded box and insert are of simple, streamlined, molded, economical construction and, according to the principles of the present invention, provides for rapid and repeated pre-wiring, wiring, or re-wiring of conventional residential, commercial, or industrial wiring systems.

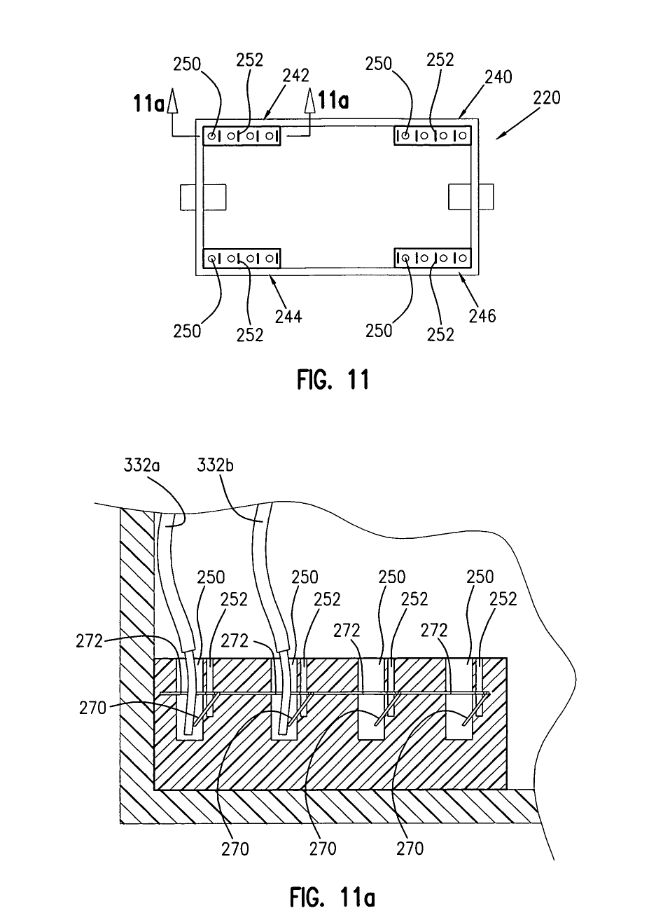

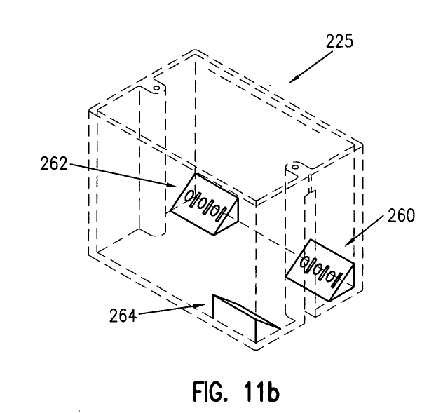

For those who prefer the electrical wire connection means to be quick connect connection means, the present electrical connection assembly for wiring electrical devices invention is available with electrical wire quick connects molded, or otherwise inserted into, the electrical connector blocks that are a molded part of a junction box as described above and below. FIG. 11 provides a top plan view of electrical receptacle connector junction box 220 according to the teachings of the present invention for receiving an electrical device, such as a switch or plug device. Electrical connector junction box 220 may be used as either a receptacle connector junction box or as a junction box, as claimed. Illustrated in FIG. 11 are four rectangularly shaped wiring terminals connector blocks 240-246 (i.e., terminals) molded as a seamless integral part of box 220 body with four wire connector apertures 250 in which electrical wires are positioned for securing and four quick connect connector release openings 252 per block that are used for disengaging the quick connect securing the inserted wire. There are many known and yet to be known styles of quick connect devices that are contemplated for use with the present invention. For example, one common quick connect connection device comprises a resilient metal leaf spring that provides as many up-turned spring tabs as needed for holding wires that are positioned in wire connector apertures. The quick connect connections are molded into the connector blocks that are molded into the inside corners of a junction box, as described above. Alternatively, quick connect connections are inserted after the molding process is complete into a space that is molded into the connector for receiving the quick connect connectors. Each junction box may have a desired number of connector blocks. If, for example, the junction box is to be used where a dual room switch is desired, a four connector block junction box would be used. Each connector block typically has from three to six wire connector apertures, but could have fewer or more if desired. For example, if the box is a double box, that is, if the function of the box is to hold, for example, a pair of plug plates, the connector blocks of that box would most likely each have four wire connector apertures.

FIG. 11a, a cross-section taken along line 11a-11a, illustrates one way a leaf spring quick connect wire connection is molded into a wiring terminal block to provide secure quick connect connectors 270 connections. Once a wire is positioned within receiving aperture 250 the sharp thin, but strong, edge of metal quick connect connector 270 “bites” into the wire to provide both a secure physical hold on the wire and an electrical connection. When it is desired to remove a wire from receiving aperture 250 where it is firmly and securely held by quick connect connector 270, one simply inserts a small tool, such as a screw driver, into the related quick connect connector release opening 252 to release the hold of the connector on the wire at which time the wire easily is pulled out of the aperture.

FIG. 11b, a perspective view show through ghost junction box 225, illustrates triangularly-shaped wire connector terminal blocks 260-246 molded as part of the inner junction box body where each connector block has four wire connector apertures and four quick connect connector release openings per block. Triangularly-shaped wire connector blocks provide for more space within the body of a junction box. There are many variations that the shape of the connector blocks can take within the principles of the present invention, including triangular shapes that would fit vertical corner axes as well as various styles of blocks that have curvilinear shapes.

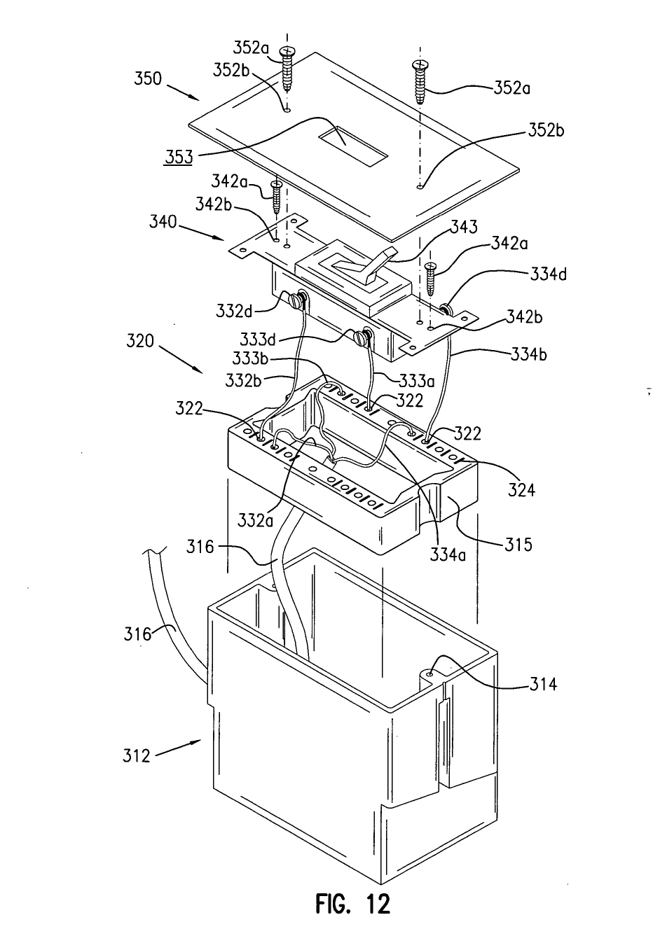

FIG. 12 illustrates another embodiment of the present invention that was discussed, in part above, i.e., a wiring terminal insert that can be easily and rapidly dropped into a presently available junction box. At this point, the use of quick connect connections as means for securing wires in the wiring terminals in the insert is introduced. FIG. 12, an exploded view, illustrates junction box 312, insert 320, electrical device switch 340, and switch plate 350. Junction box 312 typically is supplied with attachment means for attaching electrical devices to the box. Here the attachment means are apertures 314 that are used in conjunction with apertures 342b on the switch for receiving attachment means 342a for securing switch 340 to box 312. Once all the electrical connections are made from the wires carried by cable 316, including ground wire 334a, which connects to wire 334b, which is connected to switch 340 by wire connector means 334d, switch plate 350 is placed so that switch aperture 353 fits about switch 343. Switch plate 350 is then attached to switch 340 using attachment means 352a and attachment aperture 352b. Cable 316 also provides wire 332a which transports electrons from electricity source to electrical device 320. FIG. 11a, together with FIG. 12, provides an understanding of how electrons travel from a source to a device. FIG. 12 illustrates the wire paths that the electricity follows as it travels from an outside source through cable carried wire 332a to switch wire 332b, which is connected to switch 320 by connector 332d. FIG. 11a illustrates the structure of a quick connect securing and connecting means and how the conducting material of the quick connect provides for the electrical connection of two wires, such as wire 332a that is inserted into a first aperture 322 and device wire 332b that is inserted into neighboring second aperture 322. Electrical current from wire 332a travels through a first quick connect tab 270 to quick connect connecting part 272 to a second quick connect tab 270 to electrical device wire 332b which is secured to switch 340 by wire connector means 332d. Electricity flowing away from the switch flows through wire 333a connected to switch 340 by wire connecting means 333d via quick connect connecting means to wire 333b. When it is desired to disengage the wires, quick connect connector release openings 324 (see FIG. 12) are used for disengaging the quick connect tabs 270 that secure the inserted wire. How to do this is well known by those in the art, it involves only inserting a small tool, such as a screwdriver into opening 324 to push tab 270 away from the wire for release of the wire. The quick connect connections are molded into the connector blocks of the inserts just as they are molded into connector blocks that are molded into the inside corners of a junction box, as described above. Alternatively, quick connect connections may be inserted into a space that is molded into the connector for receiving the quick connect connectors. Each junction box insert may have a desired number of connector blocks, such as three or four connector blocks. If, for example, the junction box and insert are to be used where a dual room switch is desired, a four connector block junction box insert would be used. Each connector block has from three to six wire connector apertures, but could have fewer or more if desired. For example, if the insert were to be manufactured to fit a double box, that is, if the box and insert were meant to hold, for example a pair of plug plates, a connector block having four wire connector aperture sets would be used.

The foregoing description, for purposes of explanation, used specific and defined nomenclature to provide a thorough understanding of the invention. However, it will be apparent to one skilled in the art that the specific details presented are not required in order to practice the invention and are not intended to be exhaustive or to limit the invention to the precise forms disclosed. Those skilled in the art will recognize that many changes may be made to the features, embodiments, and methods of making the embodiments of the invention described herein without departing from the spirit and scope of the invention. The invention is limited only by the claims.

What is claimed is:

1. A quick connect electrical connection assembly, comprising:
a) a junction box for wiring electrical devices,
said junction box having at least one opening to receive an electric power-receiving member;
said junction box having at least one other opening to receive a cable bringing electric power to be received by said at least one power-receiving member;
b) a plurality of wiring terminals molded to said junction box at spaced locations thereon;
said plurality of molded wiring terminals each adapted to receive and securely reversibly grip using quick connect connection means at least a wire of said power-receiving member,
said plurality of molded wiring terminals each adapted to receive and securely reversibly grip using quick connect connection means at least a wire of said cable bringing power to be received by a power-receiving member;
when said wire of said power receiving member is received and secured by one of said molded wiring terminals and a wire of said cable is received and secured by the same of said molded wiring terminals the power receiving member is wired.

2. The quick connect electrical connection assembly, as recited in claim 1, wherein said junction box further comprises an receptacle junction box adapted for receiving and securing at least one electrical switch device and/or at least one electrical plug device, said at least one electrical switch device and said at least one electrical plug device each an electric power-receiving member.

3. The quick connect electrical connection assembly, as recited in claim 1, further comprising wherein said at least one wiring terminal is made of a conducting material.

4. The quick connect electrical connection assembly, as recited in claim 1, further comprising wherein said wiring terminal further comprises a block terminal.

5. The quick connect electrical connection assembly, as recited in claim 4, further comprising wherein said block terminal has multiple sets of first apertures connectedly open to second apertures.

6. The quick connect electrical connection assembly, as recited in claim 5, further comprising wherein said at least one electrical conductor is positioned into a second aperture of a first set and secured therein by a securing means positioned into a first aperture of the first set.

7. The quick connect electrical connection assembly, as recited in claim 6, further comprising wherein at least one wire of said electrical device is positioned into a second aperture of a second set and secured therein by a securing means positioned into a first aperture of the second set providing for electrical connection between said electrical conductor and said electrical device.

8. The quick connect electrical connection assembly, as recited in claim 1, wherein said molded box is molded from a plastic material.

9. A quick connect electrical connection assembly, comprising:
a) a receptacle junction box for wiring electrical switch devices and electrical plug devices,
said receptacle junction box adapted for receiving and securing at least one electrical switch device and/or at least one electrical plug device, said at least one electrical switch device and said at least one electrical plug device each an electric power-receiving member;
said receptacle junction box having at least one opening to receive a cable bringing electric power to be received by said at least one power-receiving member;
b) a plurality of wiring terminals molded to said receptacle junction box at spaced locations thereon;
said plurality of molded wiring terminals each adapted to receive and securely reversibly grip using quick connect connection means at least a wire of said cable bringing power to be received by a power-receiving member;
said plurality of molded wiring terminals each adapted to receive and securely reversibly grip using quick connect connection means at least a wire of said power-receiving member,
when said wire of said power receiving member is received and secured by one of said molded wiring terminals and a wire of said cable is received and secured by the same of said molded wiring terminals the power receiving member is wired.

10. A quick connect electrical connection assembly, comprising:
a molded wire connector insert for insertion into a junction box, comprising:
a. an insert frame having a plurality of quick connect wiring terminals manufactured as part of said insert frame at spaced locations therein for receiving wires to be connected,
said plurality of wiring terminals each adapted to receive and securely reversibly grip using quick connect connection means at least a wire of a power-receiving device,
said plurality of wiring terminals each adapted to receive and securely reversibly grip using quick connect connection means at least a wire of said cable bringing power to be received by a power-receiving device;
wherein when said wire of said power receiving device is received and secured by one of said quick connect wiring terminals and a wire of said cable is received and secured by the same of said quick connect wiring terminals the power receiving member is wired.

11. The quick connect electrical connection assembly, as recited in claim 10,
said junction box further comprising a receptacle junction box adapted for receiving and securing at least one electrical switch device and/or at least one electrical plug device, said at least one electrical switch device and said at least one electrical plug device each an electric power-receiving member.

12. The quick connect electrical connection assembly, as recited in claim 10, further comprising wherein said frame is made solely of a non-conducting material.

13. The quick connect electrical connection assembly, as recited in claim 12, further comprising wherein said non-conducting material is a plastic.

14. The quick connect electrical connection assembly, as recited in claim 12, further comprising wherein said non-conducting material is a ceramic.

15. The quick connect electrical connection assembly, as recited in claim 12, further comprising wherein said non-conducting material is a glass.

16. The quick connect electrical connection assembly, as recited in claim 10, further comprising wherein said at least one wire terminal is made of a non-conducting material.

17. The quick connect electrical connection assembly, as recited in claim 10, further comprising wherein said at least one wire terminal is made of a conducting material.

18. The quick connect electrical connection assembly, as recited in claim 10, further comprising wherein said at least one wire terminal is insulated from its environment.

19. The quick connect electrical connection assembly, as recited in claim 18, further comprising wherein said at least one conducting block is electrically insulated from the environment outside of said frame.

20. The quick connect electrical connection assembly, as recited in claim 10, further comprising wherein said frame is made of a non-conducting material having at least one non-conducting connection block for connecting said wires to be connected, said non-conducting block molded together with and within said frame.
